(19) United States
(12) Patent Application Publication
(10) Pub. No.: US 2021/0227979 A1
(43) Pub. Date: Jul. 29, 2021

(54) FOAM CHAIR WITH BACK STIFFENER

(71) Applicant: KLD IP Holdings, LLC, Neosho, MO (US)

(72) Inventor: Richard D. Davidson, Neosho, MO (US)

(21) Appl. No.: 16/773,956

(22) Filed: Jan. 27, 2020

(51) Int. Cl. A47C 5/12; A47C 7/18; B68G 7/00; A47C 7/40

(52) U.S. Cl. CPC A47C 5/12; A47C 7/40; B68G 7/00; A47C 7/185

(57) ABSTRACT

A chair is made of foam, and includes a back stiffener that reinforces the back of the chair so the back does not collapse backwards when someone leans back and puts significant weight on the back of the chair. The back stiffener can be made of a variety of different materials and can have a variety of different configurations.

### BACKGROUND

### 1. Technical Field

This disclosure generally relates to seating, and more specifically relates to foam chairs.

### 2. Background Art

Mankind has invented various types of seating throughout the centuries. Stools and chairs have been developed that have many different shapes and configurations. Many chairs include wood and/or metal that requires a workman to fabricate the chair components, and an assembly person to assemble the components into a chair. This can lead to chairs that are relatively expensive to produce.

Recent advances have recognized that chairs can be made very inexpensively and very light if they are made of foam. A chair can be cut from a single block of foam, thereby reducing the costs when compared to manufacturing components and assembling components into a chair. However, foam is not as rigid as wood, steel, or many plastics. This can lead to the back of a foam chair collapsing if a person seated on chair leans back and puts significant weight on the back of the chair.

### BRIEF SUMMARY

A chair is made of foam, and includes a back stiffener that reinforces the back of the chair so the back does not collapse backwards when someone leans back and puts significant weight on the back of the chair. The back stiffener can be made of a variety of different materials and can have a variety of different configurations. Examples of suitable configurations include a planar piece that is attached to the back of a foam chair, an L-shaped piece that is attached to the back and the bottom of a foam chair, a planar piece that is slipped into a slot in the back of the chair and attached to the back of the chair, and an L-shaped piece that has one leg of the L slipped into a slot in the back of the chair and the other leg of the L attached to the bottom of the chair. The back stiffener can include one or more openings that increases the flexibility of the back stiffener when the back stiffener is twisted. The back stiffener can also include one or more retaining members that help hold the back stiffener to the back of the chair.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is an upper perspective view of a foam chair with a back stiffener;

FIG. 2 is a left side view of the foam chair in FIG. 1, where the right side view is a mirror image;

FIG. 3 is a top view of the chair shown in FIG. 1;

FIG. 4 is a bottom view of the chair shown in FIG. 1;

FIG. 5 is a back view of the chair shown in FIG. 1;

FIG. 6 is a front view of the chair shown in FIG. 1;

FIG. 7 is a planar view of a solid back stiffener;

FIG. 8 is a side view of the solid back stiffener shown in FIG. 7;

FIG. 9 is a planar view of a back stiffener that includes a plurality of long slots;

FIG. 10 is a planar view of a back stiffener that includes a plurality of short slots;

FIG. 11 is a planar view of a back stiffener that includes a plurality of holes;

FIG. 12 is a side view of a back stiffener that includes an array of straight retaining members;

FIG. 13 is a side view of a back stiffener that includes an array of curved retaining members;

FIG. 14 is a side view of an L-shaped back stiffener;

FIG. 15 is a planar view of a back stiffener that includes longitudinal reinforcing ribs;

FIG. 16 is a side view of the back stiffener in FIG. 15;

FIG. 17 is a top view of the back stiffener in FIGS. 15 and 16;

FIG. 18 is a side view of a lounge chair that includes a back stiffener;

FIG. 19 is a side view of a lounge chair that includes a back stiffener that has two legs disposed at an angle with respect to each other;

FIG. 20 is a side view of a chair that includes a slot into which a planar back stiffener is placed and attached;

FIG. 21 is a side view of a chair that includes a slot into which one leg of an L-shaped back stiffener is placed and attached, with the other leg underlying and attached to the bottom of the chair;

FIG. 22 is a flow diagram of a first method for fabricating a chair with a back stiffener; and

FIG. 23 is a flow diagram of a second method for fabricating a chair with a back stiffener.

### DETAILED DESCRIPTION

A chair is made of foam, and includes a back stiffener that reinforces the back of the chair so the back does not collapse backwards when someone leans back and puts significant weight on the back of the chair. The back stiffener can be made of a variety of different materials and can have a variety of different configurations. Examples of suitable configurations include a planar piece that is attached to the back of a foam chair, an L-shaped piece that is attached to the back and the bottom of a foam chair, a planar piece that is slipped into a slot in the back of the chair and attached to the back of the chair, and an L-shaped piece that has one leg of the L slipped into a slot in the back of the chair and the other leg of the L attached to the bottom of the chair. The back stiffener can include one or more openings that increases the flexibility of the back stiffener when the back stiffener is twisted. The back stiffener can also include one or more retaining members that help hold the back stiffener to the back of the chair.

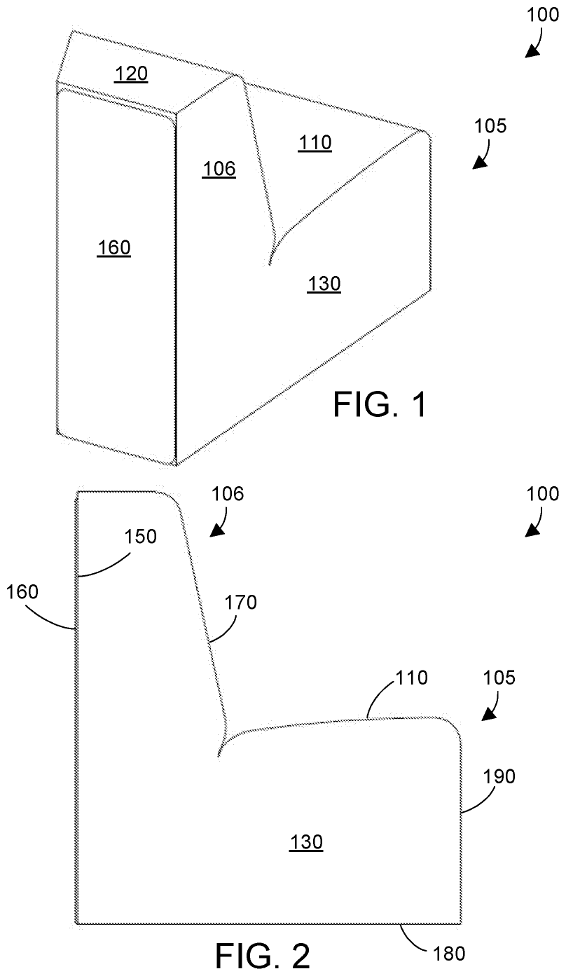

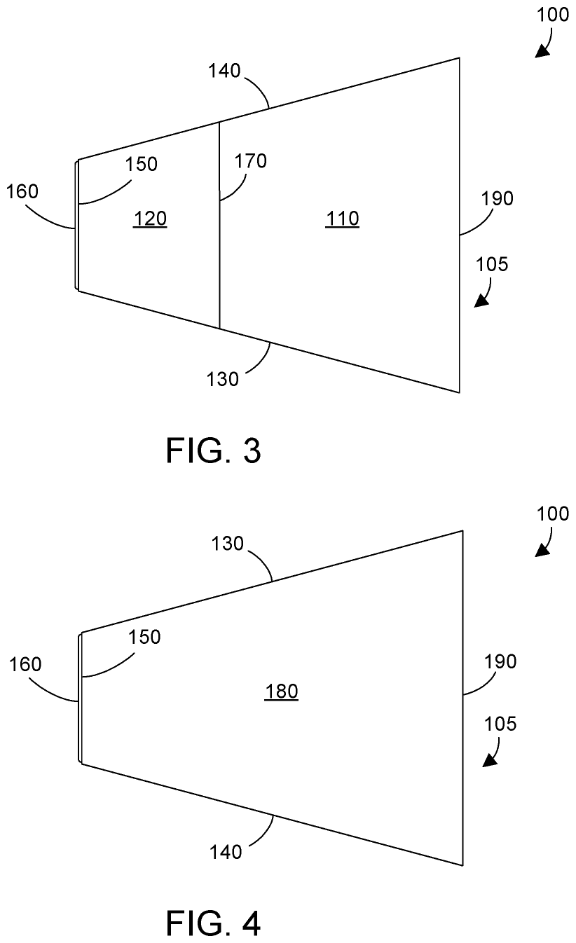

FIGS. 1-6 show various views of one particular embodiment for a foam chair 100 in accordance with the disclosure and claims herein. The foam chair 100 includes foam chair body 105 and a back stiffener 160. The foam chair body 105 includes a seat 110, a top 120, a left side 130, a right side 140, a back 106, a bottom 180, and a front 190. The back 106 preferable includes a seat back 170 on one side and a back surface 150 on the opposing side. The foam chair body is most preferably formed from a single piece of foam. Urethane foam is one suitable foam that could be used. Polyurethane form is another suitable foam that could be used. Of course, other foams could be used, and the disclosure and claims herein expressly extend to any suitable foam in any suitable density that can support the weight of person seated on the seat 110. Note that chairs designed for small children could have foam of significantly less density than chairs designed for adults due to the weight differences between small children and adults.

In the most preferred embodiment that uses urethane or polyurethane foam, the preferred density of the foam is at least 1.9 lb per cubic foot (30.4 kg per cubic meter). Of course, much higher densities can be used, but this comes at an increased expense because a higher density foam means more material is required to make the foam. An optimum density of foam will provide the required support with a minimum amount of foam per volume to minimize the cost of fabricating the foam chair.

The softness or firmness of foam is often measured using Indention Force Deflection (IFD). IFD is also known as Initial Load Deflection (ILD) or Compression Force Deflection (CFD). IFD is determined by measuring how much weight is necessary to make a piece of foam compress by 25%. A test is done by measuring the height of a piece of foam, then placing a weighted circular disk at the center of the piece of foam. Weight is added until the foam has compressed by 25%, which means the height of the foam has reduced to 75% of its original height. The amount of weight it takes to reach 25% compression is the IFD number, which means if it takes 50 lb (22.7 kg) to compress the foam 25%, the foam has an IFD of 50.

The IFD of the foam body is preferably at least 70, is more preferably at least 75, and is most preferably 75-80.

The foam body 105 can be formed in any suitable way. In the most preferred implementation, the foam body 105 is formed by starting with a block of foam that has parallel planar surfaces, then cutting away unwanted portions of the foam block to arrive at a foam body, such as 105 shown in FIGS. 1-6. Any suitable method for cutting the foam can be used. In the most preferred embodiment, a computer numeric control (CNC) slicing knife is used to cut the block of foam.

The foam body 105 has a back 106 with a seat back 170 on one side and a back surface 150 on the opposing side. The back surface 150 has a back stiffener 160 attached. The back stiffener 160 provides structural reinforcement so the back 106 does not bend backwards (or collapse) when a person seated on the seat 110 leans back and puts weight against the seat back 170. Without the back stiffener 160, the back 106 would likely collapse backwards when a person seated on the seat 110 leans back and puts weight against the seat back 170. The back stiffener thus provides a structural support to prevent the back 106 from collapsing from the weight of a person leaning and putting weight against the seat back 170.

In one preferred implementation, the back stiffener 160 is a substantially planar member that is glued to the back surface 150 using a suitable adhesive. One example of a suitable adhesive is Fast Tack Adhesive Spray manufactured and sold by Prime Industries in Thornton, Colo. Of course, any suitable adhesive could be used to attach the back stiffener 160 to the back surface 150. In addition, other means of attachment could be used, including screws, anchors, etc. For example, in one suitable implementation, there could be buttons on the seat back 170 that have thread or string that is passed through the seat back 170 to attach the back stiffener 160 to the back surface 150. Any suitable methods or mechanisms can be used to attach the back stiffener 160 to the back surface 150 within the scope of the disclosure and claims herein.

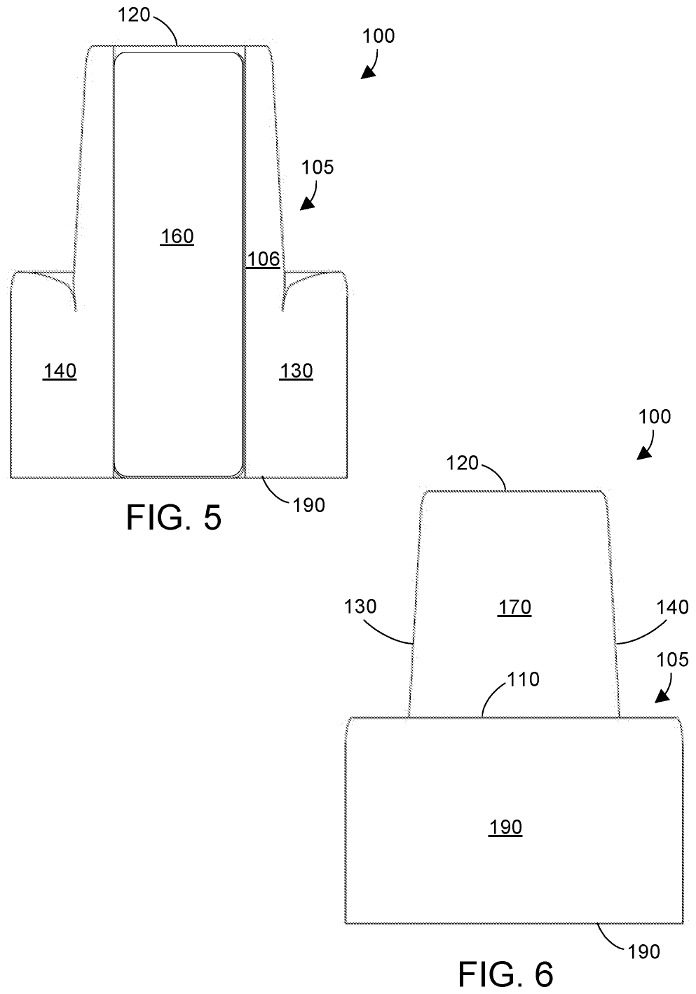

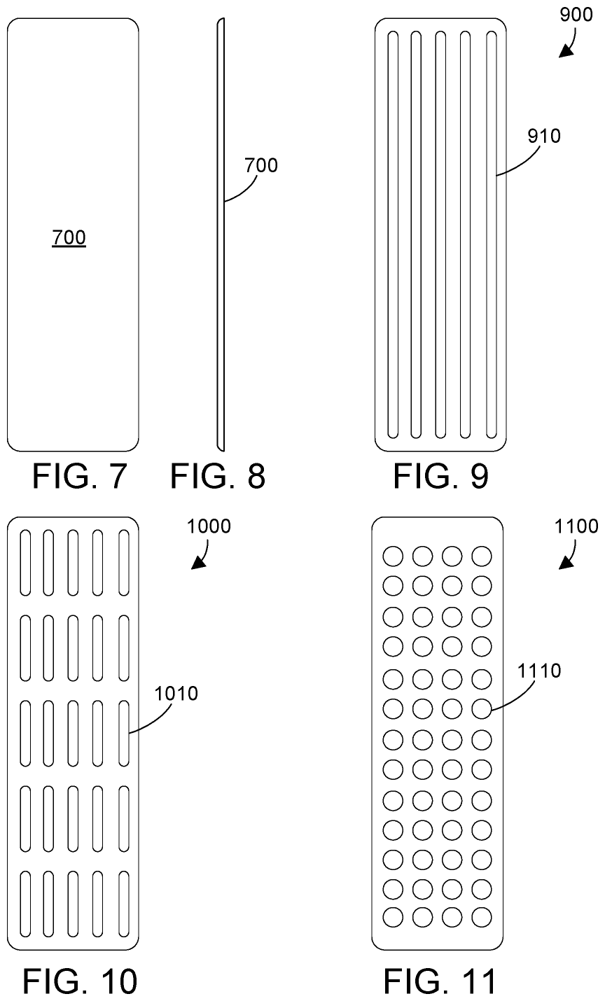

While the back stiffener 160 is shown in FIGS. 1 and 5 as a solid planar piece, there are many different possible configurations for the back stiffener within the scope of the disclosure and claims herein. Some non-limiting examples of different configurations are shown in FIGS. 7-17. FIG. 7 shows a back stiffener 700 that is a substantially planar solid piece, and could represent one suitable configuration for the back stiffener 160 shown in FIGS. 1-6. FIG. 8 shows a side view of the back stiffener 700 in FIG. 8. An alternative configuration for the back stiffener is shown in FIG. 9, which shows the back stiffener 900 includes several elongated slots 910. The elongated slots 910 reduce the cost of the back stiffener 900 due to using less material, and also provide an added benefit of providing greater torsional flexibility when a person puts uneven weight on the seat back, thereby providing a twisting motion to the back of the chair.

FIG. 10 shows another suitable configuration for a back stiffener 1000 that includes multiple shorter slots 1010. FIG. 11 shows yet another suitable configuration for a back stiffener 1100 that includes multiple circular holes 1110. The examples in FIGS. 9-11 are shown to illustrate the back stiffener disclosed herein can include any suitable type of number of openings.

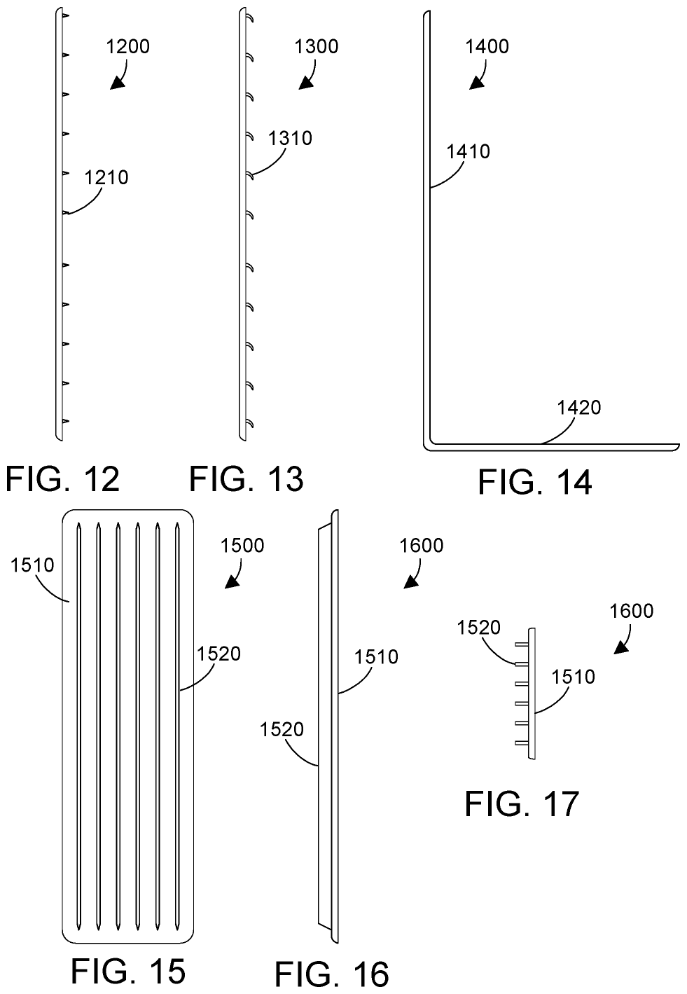

The back stiffener disclosed and claimed herein may also include one or more retaining members that serve to keep the back stiffener in a desired position on the back of the foam chair. Two suitable examples of retaining members are shown in FIGS. 12 and 13. In FIG. 12, the back stiffener 1200 includes multiple straight spike-shaped retaining members 1210 that press into the foam to help retain the back stiffener 1200 to the back of a foam chair. In FIG. 13, the back stiffener 1300 includes multiple curved retaining members 1310 that are pressed into the foam to help attach the back stiffener 1300 to the back of a foam chair. Note that any of the back stiffeners shown in FIGS. 7 and 9-11 could include either or both of the types of retaining members shown in FIGS. 12 and 13. Of course, a variety of other configurations or retaining members could be used, and are within the scope of the disclosure and claims herein.

FIG. 14 shows an L-shaped back stiffener 1400 that has a first leg 1410 and a second leg 1420. The first leg 1410 could be attached to the back of the chair similar to how the back stiffener 160 in FIG. 2 is attached to the back surface 150 of the chair body 105. The second leg 1420 could be attached to the bottom 180 of the chair body 105 shown in FIG. 2. The L-shaped back stiffener 1400 provides additional support because the L-shape provides structural strength between the two legs, thereby providing increased strength when compared to a planar back stiffener such as 160 shown in FIGS. 1-6.

Yet another possible configuration for a back stiffener is shown in FIGS. 15-17, which shows a planar view in FIG. 15, a side view in FIG. 16, and a top/bottom view in FIG. 17. The back stiffener 1500 includes a planar surface 1510 from which extend multiple reinforcing ribs 1520. In one suitable implementation, the planar surface 1510 and reinforcing ribs 1520 are formed of the same material, such as injection-molded plastic or pressboard. In an alternative implementation, the planar surface 1510 could be made of a different material than the reinforcing ribs 1520, with the reinforcing ribs 1520 being attached to the back of the foam chair or to the planar surface 1510 using any suitable means for attachment, including adhesive, fasteners, etc.

The back stiffener disclosed herein can be made of any suitable material or combinations of materials. In one suitable implementation, the back stiffener is made of a piece of flat wood, such as plywood or pressboard. For example, one suitable specific embodiment uses 5.5 mm thick medium density fiberboard (MDF). In another suitable implementation, the back stiffener is made of molded or extruded plastic. In yet another suitable implementation, the back stiffener is made of glass fibers or carbon fibers. In addition, various combinations could be used, such as using carbon fibers for the reinforcing ribs 1520 in FIGS. 15-17 while using glass fibers or plastic for the planar portion 1510. These and other variations and combinations are within the scope of the disclosure and claims herein.

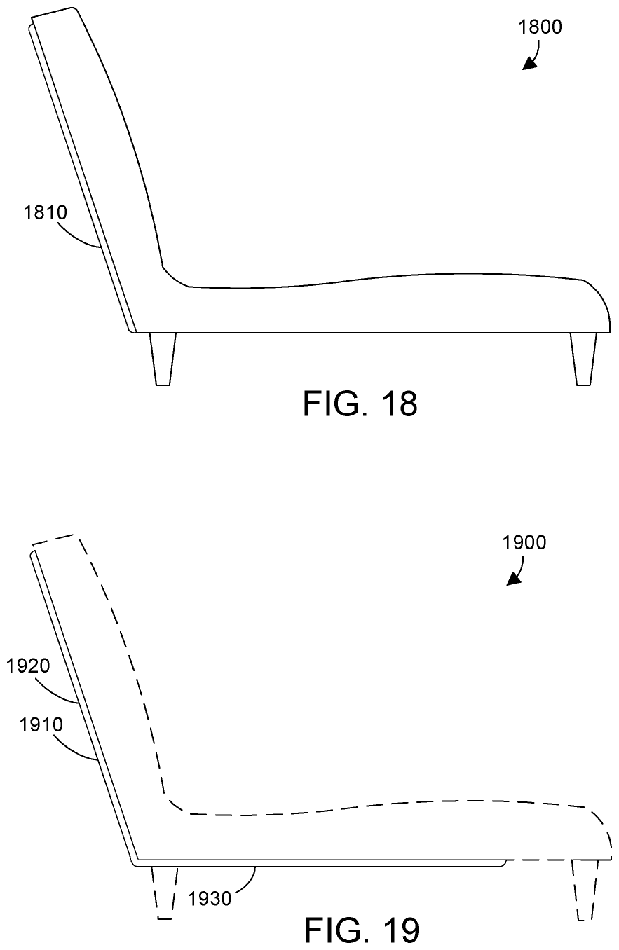

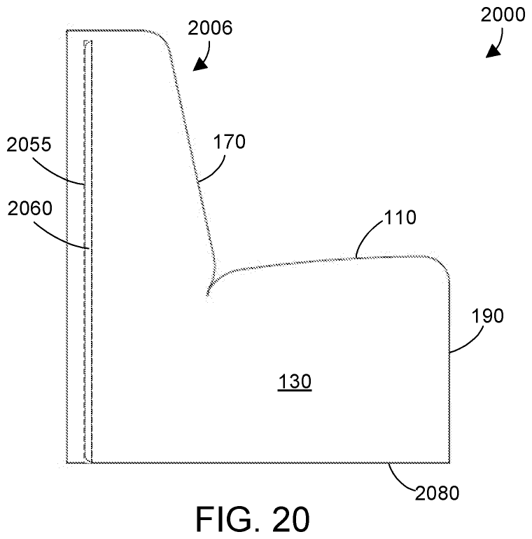

A back stiffener as disclosed herein could be used on any suitable type of foam chair. For example, a lounge chair 1800 is shown in FIG. 18 that includes a planar back stiffener 1810. A similar lounge chair 1900 is shown in FIG. 19 that includes a back stiffener 1910 that includes two legs, a first leg 1920 attached to the back and a second leg 1930 attached to the bottom. The chair body in FIG. 19 is shown in phantom to make it clear that the back stiffener 1910 includes two legs 1920 and 1930. The example back stiffener 1910 in FIG. 19 makes it clear that a back stiffener can include two legs at any suitable angle with respect to each other, and is not limited to the 90 degree shape shown in FIG. 14. Note the term “L-shape” as used in the disclosure and claims herein expressly includes both the 90 degree shape shown in FIG. 14 as well as configurations where the two legs are more or less than 90 degrees from each other, for example as shown in FIG. 19.

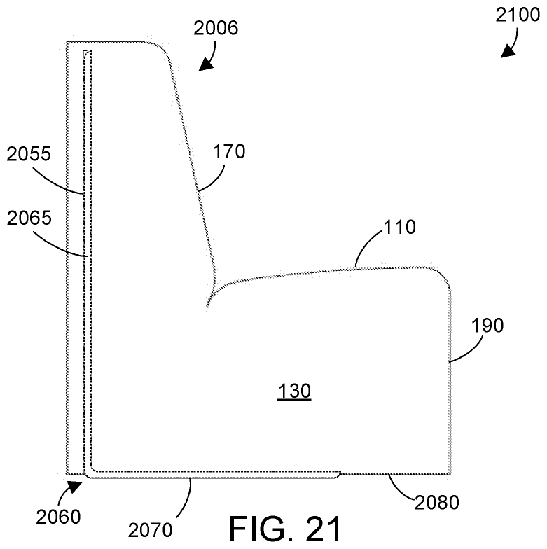

In another embodiment, the back stiffener is not attached to the back surface of the chair body, but is instead inserted into a slot in the back of the chair body. Referring to FIG. 20, a chair 2000 includes many of the same features shown in FIG. 2. However, the chair 2000 includes a slot 2055 in the back 2006 of the chair, into which the back stiffener 2060 can be inserted and attached. In an alternative configuration shown in FIG. 21, an L-shaped back stiffener 2060 has a first leg 2065 that is inserted into a slot 2055 in the back 2006, and a second leg 2070 that is attached to the bottom 2080 of the chair. In this configuration, the first leg 2065 could be inserted into the slot 2055 without attaching the first leg 2065 to the foam because once the second leg 2070 is attached to the bottom 2080, the first let 2065 will be held properly in place within the slot 2055. The L-shaped chair stiffener 2060 shown in FIG. 21 provides increased strength because the weight of a person seated on the seat 110 will press down against the second leg 2070 on the bottom 2080 of the chair, and the first leg 2065 will then provide increased strength and resistance to bending due to its connection with the second leg 2070.

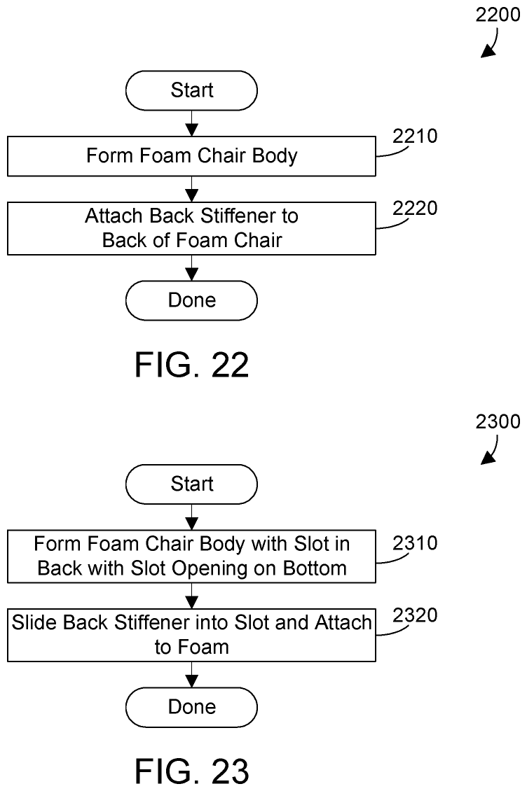

Referring to FIG. 22, a first method 2200 for manufacturing a chair in accordance with the disclosure and claims herein begins by forming the foam chair (step 2210). The foam chair can be formed in any suitable way. One specific example is to use a block of form, then cut away the unwanted foam to provide a chair body that includes a foam seat and a foam back. Another specific example is to cut the foam seat and foam back separately, then attach the foam seat to the foam back using a suitable adhesive. A back stiffener is then attached to the back of the foam chair (step 2220). The back stiffener can have any suitable configuration made of any suitable material, and can be attached using any suitable attachment means, including adhesive and fasteners. Method 2200 is then done.

Referring to FIG. 23, a second method 2300 for manufacturing a chair in accordance with the disclosure and claims herein begins by forming the foam chair body with a slot in the back that has a slot opening on the bottom (step 2310). As in step 2210 in FIG. 22, the foam chair can be formed in any suitable way. A back stiffener is then slid into the slot and attached to the foam (step 2320). Once again, the back stiffener can have any suitable configuration made of any suitable material, and can be attached using any suitable attachment means, including adhesive and fasteners. Method 2300 is then done.

A chair is made of foam, and includes a back stiffener that reinforces the back of the chair so the back does not collapse backwards when someone leans back and puts significant weight on the back of the chair. The back stiffener can be made of a variety of different materials and can have a variety of different configurations. Examples of suitable configurations include a planar piece that is attached to the back of a foam chair, an L-shaped piece that is attached to the back and the bottom of a foam chair, a planar piece that is slipped into a slot in the back of the chair and attached to the back of the chair, and an L-shaped piece that has one leg of the L slipped into a slot in the back of the chair and the other leg of the L attached to the bottom of the chair. The back stiffener can include one or more openings that increases the flexibility of the back stiffener when the back stiffener is twisted. The back stiffener can also include one or more retaining members that help hold the back stiffener to the back of the chair.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A chair comprising:
a single piece of foam in an L-shape having a horizontal portion of the L-shape that defines a foam seat and a vertical portion of the L-shape that defines a foam back having a front portion that supports a back of a seated person and a back portion opposite the front portion, wherein the back portion is substantially planar; and
a substantially planar back stiffener attached via adhesive to the back portion of the foam back to prevent the foam back from collapsing backward when the seated person seated on the foam seat leans back and puts weight on the back portion of the foam back, wherein the substantially planar back stiffener is an exposed exterior surface of the chair.

2-3. (canceled)

4. The chair of claim 1 wherein the back stiffener comprises a plurality of openings.

5. The chair of claim 1 wherein the back stiffener comprises an L-shape with two legs, wherein a first of the two legs is attached to the back portion of the foam back and a second of the two legs is attached to a bottom of the chair.

6. The chair of claim 1 wherein the back stiffener comprises a substantially planar piece of wood.

7. The chair of claim 1 wherein the back stiffener comprises a substantially planar piece of plastic.

8. The chair of claim 1 wherein the back stiffener comprises:
a substantially planar portion; and
a plurality of retaining members extending from the substantially planar portion that engage the back to help hold the back stiffener to the back.

9. The chair of claim 1 wherein the back stiffener comprises a piece of molded plastic comprising:
a substantially planar base; and
a plurality of reinforcing ribs extending from the substantially planar base.

10. The chair of claim 1 wherein the back comprises a slot that receives the back stiffener.

11. The chair of claim 10 wherein the back stiffener comprises an L-shape with two legs, wherein a first of the two legs is placed within the slot and a second of the two legs is attached to a bottom of the chair with adhesive.

12. A method for manufacturing a chair comprising:
cutting a single piece of foam to form an L-shape having a horizontal portion of the L-shape that defines a foam seat and a vertical portion of the L-shape that defines a foam back having a front portion that supports a back of a seated person and a back portion opposite the front portion, wherein the back portion is substantially planar; and
attaching a substantially planar back stiffener via adhesive to the back portion of the foam back to prevent the foam back from collapsing backward when the seated person seated on the foam seat leans back and puts weight on the back portion of the foam back, wherein the substantially planar back stiffener is an exposed exterior surface of the chair.

13-14. (canceled)

15. The method of claim 12 wherein the back stiffener comprises a plurality of openings.

16. The method of claim 12 wherein the back stiffener comprises an L-shape with two legs, wherein a first of the two legs is attached to the back portion of the foam back and a second of the two legs is attached to a bottom of the chair.

17. The method of claim 12 wherein the back stiffener comprises a substantially planar piece of wood.

18. The method of claim 12 wherein the back stiffener comprises a substantially planar piece of plastic.

19. The method of claim 12 wherein the back stiffener comprises:
a substantially planar portion; and
a plurality of retaining members extending from the substantially planar portion that engage the back to help hold the back stiffener to the back.

20. The method of claim 12 wherein the back stiffener comprises a piece of molded plastic comprising:
a substantially planar base; and
a plurality of reinforcing ribs extending from the substantially planar base.

21. The method of claim 12 wherein the back comprises a slot that receives the back stiffener.

22. The method of claim 21 wherein the back stiffener comprises an L-shape with two legs, wherein attaching a back stiffener to the foam back comprises placing a first of the two legs within the slot and securing a second of the two legs to a bottom of the chair with adhesive.
